(19) United States
(12) Patent Application Publication
(10) Pub. No.: US 2008/0052211 A1
(43) Pub. Date: Feb. 28, 2008

(54) METHOD AND SYSTEM FOR PROTECTING AN INVESTMENT OF A LIFE INSURANCE POLICY

(76) Inventors: Alan H. Buerger, Wyndmoor, PA (US); Reid S. Buerger, Playmouth Meeting, PA (US); Alex Seldin, Philadelphia, PA (US)

Correspondence Address: DICKSTEIN SHAPIRO LLP, 1825 Eye Street NW, Washington, DC, 20006-5403, US

(21) Appl. No.: 11/763,221

(22) Filed: Jun. 14, 2007

Related U.S. Application Data
(60) Provisional application No. 60/813,335, filed on Jun. 14, 2006.

(51) Int. Cl. G06Q 40/00

(52) U.S. Cl. 705/36 R

(57) ABSTRACT

A method and system for insuring against a potential loss in future value of a life insurance policy by providing a stated value insurance policy (“SV Policy”). The SV Policy is purchased by the owner of the life insurance policy contemporaneously with the purchase of the life insurance policy or at any time thereafter. If, at a specified future time(s), the life insurance policy is determined to be worth less than a predetermined value as set forth in the SV Policy, then the SV Policy issuer pays the owner the difference between the amount covered by the SV Policy and the then-current value, assuming that the owner has satisfied the terms and conditions of the SV Policy. In another aspect, a life insurance policy owner enters into an agreement (“Lifegain Agreement”) with a third party (“Lifegain Provider”) to protect against the possibility that the life insurance policy will lose value. The Lifegain Agreement is purchased by the owner of the life insurance policy contemporaneously with the purchase of the life insurance policy or at any time thereafter. If, at a specified future time(s), the life insurance policy is determined to be worth less than a predetermined projected value as set forth in the Lifegain Agreement, the Lifegain Provider may either purchase the life insurance policy for the projected value or pay the owner the difference between the projected value and the then-current value, assuming that the owner has satisfied the terms and conditions of the Lifegain Agreement.

### BACKGROUND

The present invention relates to a method and apparatus for protecting the value of a life insurance policy.

Prospective life insurance policy owners (“owners”) purchase life insurance policies for many reasons, including to protect their beneficiaries from being financially unprepared for the death of the insured.

However, it is possible that an owner's personal circumstances will change or the life insurance policy will not perform as expected, and thus it may become desirable for the owner to seek other options, such as a sale of the life insurance policy. However, at the time the owner goes to sell the life insurance policy, the value of the policy, i.e., the price that the policy would bring in an open and competitive secondary market for life insurance or otherwise, may be less than what the owner had expected or planned for. As such, there is a need for the owner to reduce his potential exposure against this type of risk.

### SUMMARY

Exemplary embodiments of the present invention provide for a method and system for insuring against a potential loss in expected value of a life insurance policy. In an embodiment the risk of potential loss is minimized by purchasing a stated value insurance policy (“SV Policy”). The SV Policy is purchased by the owner of the life insurance policy or an interested party contemporaneously with the purchase of the life insurance policy or at any time thereafter. If, at a specified future time(s), the then-current value of the life insurance policy is less than the amount covered under the SV Policy the issuer of the SV Policy will pay the owner the difference.

In another exemplary embodiment, the risk of potential loss is minimized by an option agreement (“Lifegain Agreement”) with a third party (“Lifegain Provider”). The Lifegain Agreement is entered into by the owner of the life insurance policy or an interested party contemporaneously with the purchase of the life insurance policy or at any time thereafter. If, at a specified future time(s), the owner believes that a sale of the life insurance policy will result in proceeds less than the projected value (the “Projected Value”) of the life insurance policy at such future time(s) as set forth in the Lifegain Agreement, the owner may choose to exercise his rights under the Lifegain Agreement. The Lifegain Provider then, in its discretion, may either purchase the life insurance policy for the Projected Value or pay the owner the difference between the Projected Value and the then-current value.

### BRIEF DESCRIPTION OF THE DRAWINGS

The foregoing and other advantages and features of the invention will become more apparent from the detailed description of the exemplary embodiments of the invention given below with reference to the accompanying drawings, in which:

FIG. 1 is a schematic diagram illustrating the interaction of the parties in the method and system according to an exemplary embodiment of the invention.

FIG. 2 is a flowchart illustrating the method and system of FIG. 1.

FIG. 3 is a computer system for implementing the method and system of FIG. 1.

FIG. 4 is a schematic diagram illustrating the interaction of the parties in the method and system according to another exemplary embodiment of the invention.

FIG. 5 is a flowchart illustrating the method and system of FIG. 4.

FIG. 6 is a computer system for implementing the method and system of FIG. 4.

### DETAILED DESCRIPTION OF PREFERRED EMBODIMENTS

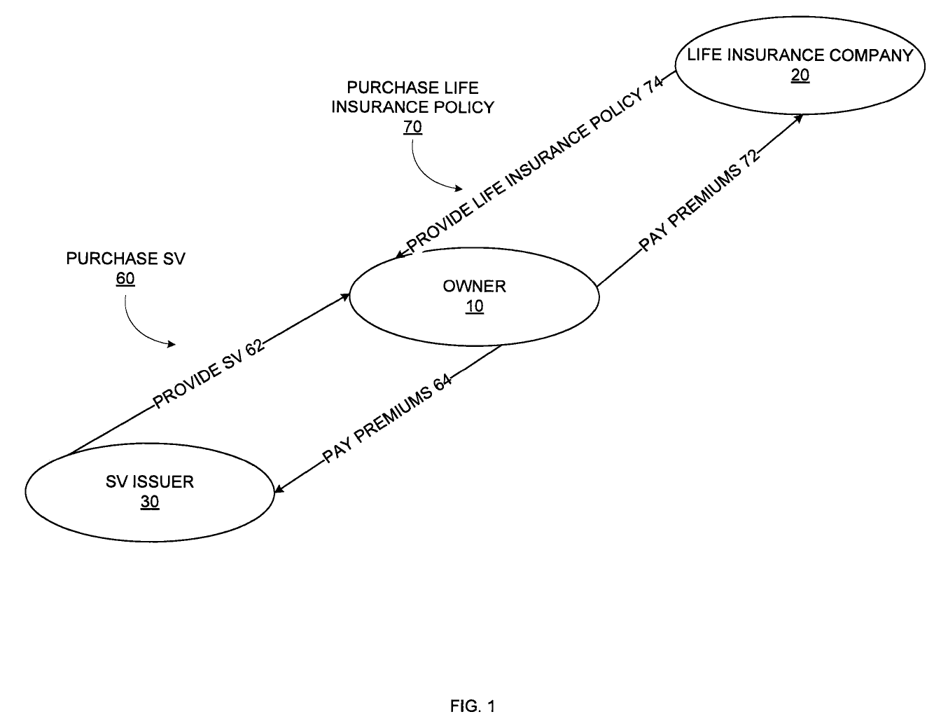

Now referring to the drawings, where like reference numerals designate like elements, there is an exemplary embodiment of the invention shown in FIG. 1 illustrating an owner 10 who has purchased 70 a life insurance policy 74 from a life insurance company 20. The owner 10 is responsible for making periodic premium payments 72 to the life insurance company 20 in order to keep the life insurance policy 74 in force. The owner 10, or any named beneficiary of the owner, is also entitled to any benefit conferred by the life insurance policy 74.

As also shown in FIG. 1, the owner 10 purchases an SV Policy 62 by paying the SV Policy issuer 30 a premium(s) 64. The SV Policy 62 insures the value of the life insurance policy 74 to be $Z at a predetermined time in the future

In a preferred embodiment, as part of the sale of the SV Policy 62, the SV Policy issuer 30 includes certain terms and conditions that must be satisfied in order for the owner 10 to make a claim under the SV Policy 62. These conditions may include a temporal scope of coverage, a ‘right to full disclosure’ provision, and a right to verify the value of the life insurance policy 74. Although not discussed here, many other provisions may be included into an SV Policy 62.

Under a temporal scope provision the SV Policy issuer 30 specifies a time period within which the owner 10 may make a claim under the SV Policy 62 and within which the then-current value of the life insurance policy is established. Each of these events may be a same or different time periods.

Under a ‘right to full disclosure’ provision an owner 10 promises to provide the SV Policy issuer 30 with all details and communications regarding any offers, correspondence, solicitation for offers, and the like that the owner 10 has received regarding the life insurance policy 74.

Under a verification provision the SV Policy issuer 30 is given the power to substantiate any existing offer(s) for the purchase of the life insurance policy 74 and (directly or indirectly) obtain additional offers in order to determine the then-current value of the life insurance policy 74.

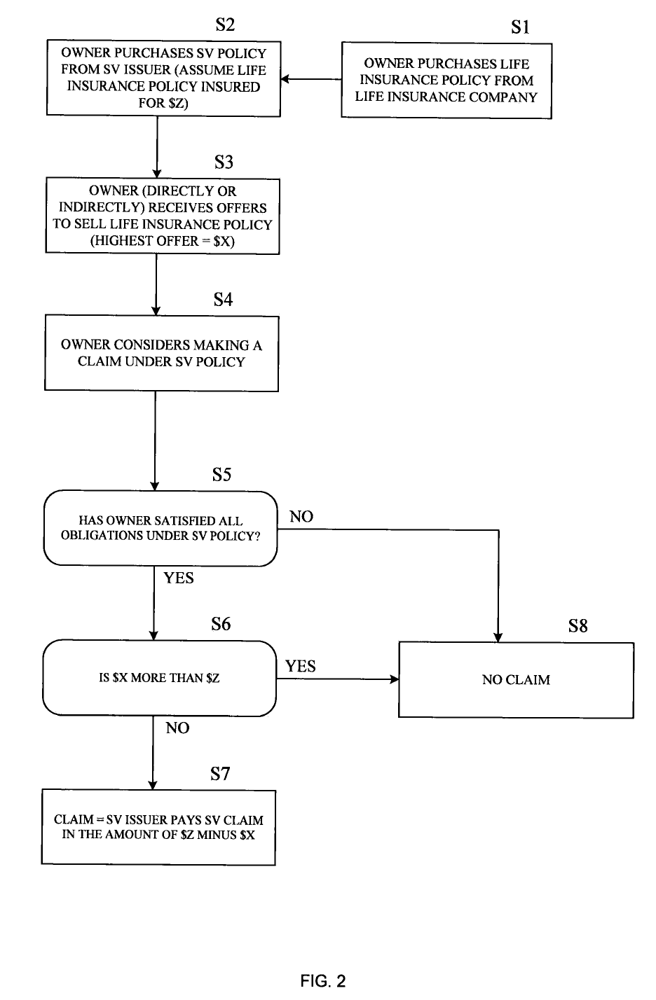

FIG. 2 illustrates a life insurance sale 70 and SV Policy claim process according to an exemplary embodiment of the principles of the present invention. A life insurance policy owner 10 purchases a second insurance policy, the SV Policy 62, to insure the future value of the life insurance policy. The owner 10 can make a claim under the SV Policy 62 if (i) the owner complies with the terms and conditions of the SV Policy 62 and (ii) at the time a claim is made under the SV Policy 62, the then-current value of the life insurance policy 74 is less than the amount covered by the SV Policy 62.

In segment S1, the owner 10 purchases 70 a life insurance policy 74 from a life insurance company 20. The process continues to segment S2.

In segment S2, the owner 10 purchases 60 an SV Policy 62 from the SV Policy issuer 30. The SV Policy 62 insures the value of the life insurance policy 74 for $Z at a predetermined time in the future. The process continues to segment S3.

In segment S3, in order to determine the then-current value of the life insurance policy 74, the owner 10 (directly or indirectly) receives offers to sell the life insurance policy 74 in the secondary market or otherwise. The best and/or highest offer is $X. The process continues to segment S4.

In segment S4, the owner 10 considers making a claim under the SV Policy 62. The process continues to segment S5.

In segment S5, the SV Policy issuer 30 must determine whether the owner 10 has complied with the terms and conditions of the SV Policy 62. If the SV Policy issuer 30 determines the owner 10 has not complied with the terms and conditions of the SV Policy 62, then the process continues to segment S8 and there is no claim and the process ends. If the SV Policy issuer 30 determines the owner 10 has complied with the terms and conditions of the SV Policy 62, then the process continues to segment S6.

In segment S6, the SV Policy issuer 30 reviews the offers that have been received for the life insurance policy 74 and determines whether $X is more than $Z. If the SV Policy issuer 30 that determines $X is more than $Z, then the process continues to segment S8 and there is no claim and the process ends. If the SV Policy issuer 30 that determines $X is not more than $Z, then the process continues to segment S7.

In segment S7, the owner 10 makes a claim under the SV Policy 62 and the SV Policy issuer 30 pays the owner 10 the difference between $Z and $X, and the process ends.

Thus, at the end of the process, if the then-current value of the life insurance policy 74 is less than $Z and the owner 10 has complied with the terms and conditions of the SV Policy 62, then the owner has a claim under the SV Policy 62 for $Z minus $X. If the owner 10 does not comply with the terms and conditions of the SV Policy 62 or sells or has an offer to sell the life insurance policy 74 for more than $Z, then the owner 10 will not have a claim under the SV Policy 62.

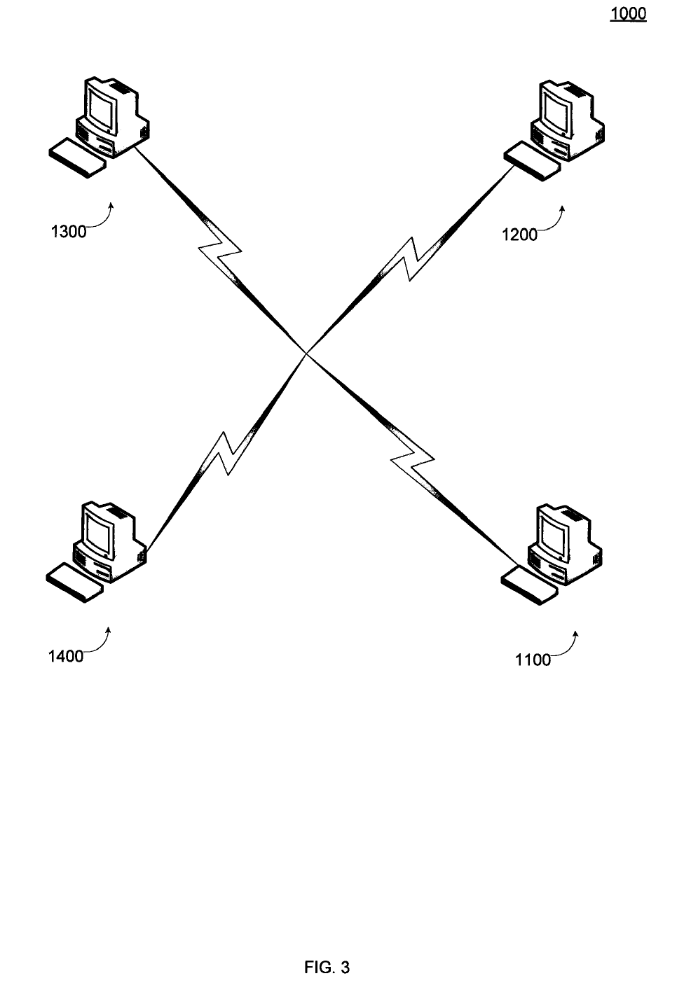

FIG. 3 illustrates that in a preferred embodiment, computers 1100, 1200, 1300, and 1400, respectively used by the owner 10, life insurance company 20, SV Policy issuer 30, and third parties 40 that make offers to purchase the life insurance policy 74 from the owner 10 may each be coupled to a network 1000. The network 1000 may be, for example, the Internet or any other wide area or even local area network. A portion of the network 1000, for example, between the owner computer 1100 and the life insurance company computer 1200, may be a local area network, while another portion of the network 1000 (or the entire network) may be part of the Internet. In an embodiment, the SV Policy issuer 30 can use its computer 1300 to determine whether the conditions of the SV Policy 62 have been complied with before performing their obligations under the SV Policy 62. Additionally, in another aspect of the invention, the computers 1100, 1200, 1300, and 1400 are used to implement additional features. The computers 1100, 1200, 1300, and 1400 may include at least one world-wide-web server for supporting one or more web based applications for performing the above described tasks. The web based application(s) may be accessible on one or more intranets. The web based application(s) may also be accessible over the global Internet.

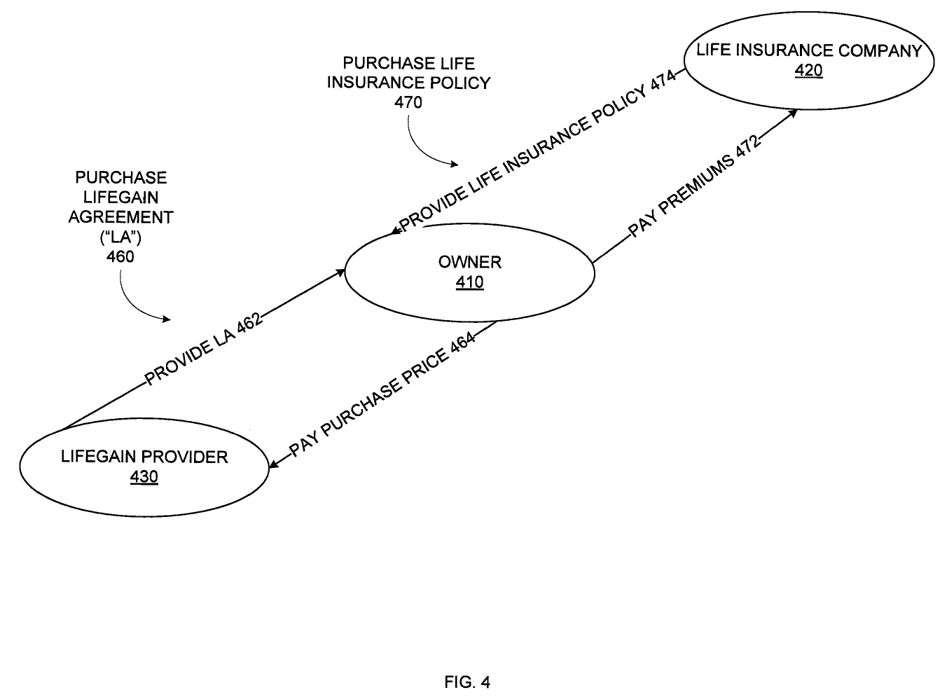

Another exemplary embodiment of the invention is shown in FIG. 4 illustrating an owner 410 who has purchased 470 a life insurance policy 474 from a life insurance company 420. The owner 410 is responsible for making periodic premium payments 472 to the insurance company 420 in order to keep the life insurance policy 474 in force. The owner 410, or any named beneficiary of the owner, is also entitled to any benefit conferred by the life insurance policy 474.

As also shown in FIG. 4, the owner 410 purchases 460 a Lifegain Agreement 462 by paying a Lifegain Provider 430 a purchase price 464. The Lifegain Agreement 462 includes a Projected Value of the associated life insurance policy 474. The Lifegain Agreement 462 is purchased contemporaneously with the purchase of the life insurance policy 474 or at any time thereafter.

In a preferred embodiment, as part of the purchase 460 of the Lifegain Agreement 462, the Lifegain Provider 430 includes certain terms and conditions that the owner 410 must satisfy before exercising his option under the Lifegain Agreement 462. These conditions may include a temporal scope of coverage, a ‘payment discretion’ provision, a right to verify the current value of the life insurance policy 474 and a ‘right to full disclosure’ provision. Although not discussed here, many other provisions may be included in a Lifegain Agreement 462.

In an example of a temporal scope provision the Lifegain Provider 430 specifies a time period within which the owner must exercise his option under the Lifegain Agreement 462 and within which the then-current value of the life insurance policy 474 must be established. Each of these events may be a same or different time periods.

Under a ‘payment discretion’ provision the Lifegain Provider 430 has the right to choose whether to (i) purchase the life insurance policy 474 from the owner 410 for the Projected Value or (ii) pay the owner 410 a net cash settlement price. The net cash settlement price may be, for example, the difference in value between the Projected Value and the then-current value of the life insurance policy 474.

Under a verification provision the Lifegain Provider 430 is given the power to substantiate any existing offer(s) for the purchase of the life insurance policy 474 and (directly or indirectly) obtain additional offers in order to determine the then-current value of the life insurance policy 474.

Under a ‘right to full disclosure’ provision, an owner 410 promises to provide the Lifegain Provider 430 with all details and communications regarding any offers, correspondence, solicitation for offers, and the like that the owner 410 has received regarding the life insurance policy 474.

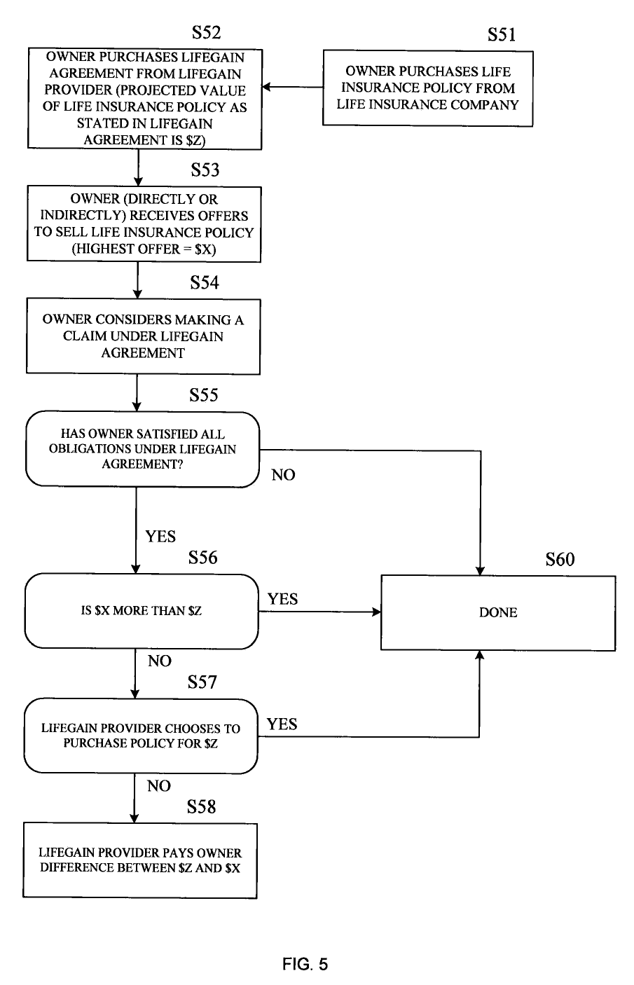

FIG. 5 illustrates a life insurance sale 470 and Lifegain Agreement election process according to an exemplary embodiment of the principles of the present invention. A life insurance policy owner 410 purchases 460 a Lifegain Agreement 462 to protect the owner's investment in a life insurance policy 474. The owner 410 can exercise his option under the Lifegain Agreement 462 if (i) the owner 410 complies with the terms and conditions of the Lifegain Agreement 462 and (ii) the then-current value of the life insurance policy 474 is less than the Projected Value.

In segment S51, the owner 410 purchases 470 a life insurance policy 474 from a life insurance company 420. The process continues to segment S52.

In segment S52, the owner 410 purchases 460 a Lifegain Agreement 462 from the Lifegain Provider 430 where the stated Projected Value of the life insurance policy 474 is $Z. The process continues to segment S53.

In segment S53, in order to determine the then-current value of the life insurance policy 474, the owner 410 (directly or indirectly) receives offers to sell the life insurance policy 474 in the secondary market or otherwise. The best and/or highest offer is $X. The process continues to segment S54.

In segment S54, the owner 410 elects to exercise his rights under the Lifegain Agreement 462. The process continues to segment S55.

In segment S55, the Lifegain Provider 430 must determine whether the owner 410 has complied with the terms and conditions of the Lifegain Agreement 462. If No, then the process continues to segment S60 and the process ends. If Yes, then the process continues to segment S56.

In segment S56, the Lifegain Provider 430 determines whether $X is more than $Z. If Yes, then the process continues to segment S60 and the process ends. If No, then the process continues to segment S57.

In segment 57, the Lifegain Provider 430 decides whether to purchase the life insurance policy 474 for $Z. If Yes, then the Lifegain Provider 430 pays the owner 410 $Z in exchange for all right, title and interest in the life insurance policy 474 and the process continues to segment S60. If No, then the process continues to segment S58.

In segment S58, the Lifegain Provider 430 pays the Owner 410 a net cash settlement in the amount of $Z minus $X and the process continues to segment S60. In an aspect of the invention, the Lifegain Agreement 462 can be modified to eliminate the cash settlement option described in this paragraph and the Lifegain Provider 430 would purchase the life insurance policy 474 for $Z as in S57.

In segment S60 the process ends.

Thus, at the end of the process, if at the time the owner 410 elects to exercise his rights under the Lifegain Agreement 462 the value of the life insurance policy 474 is determined to be less than $Z and the owner 410 complies with the terms and conditions of the Lifegain Agreement 462, the Lifegain Provider 430 will either purchase the life insurance policy 474 from the owner 410 for $Z or pay the owner 410 a net cash settlement in the amount of $Z minus $X. If the owner 410 does not comply with the terms and conditions of the Lifegain Agreement 462 or sells or has an offer to sell the life insurance policy 474 for more than $Z, then the Lifegain Provider 430 is not required to pay the owner 410 under the Lifegain Agreement 462.

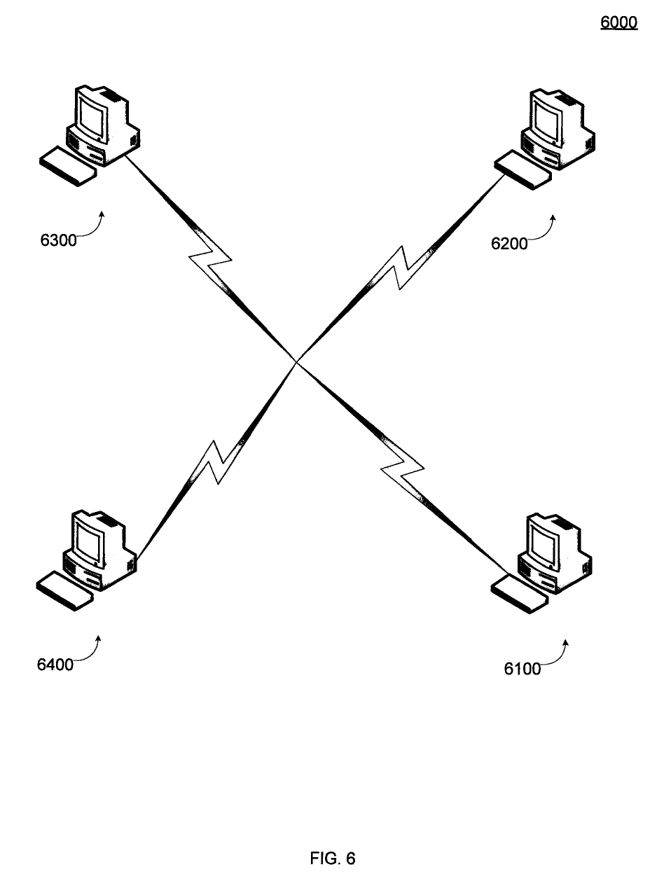

FIG. 6 illustrates that in a preferred embodiment, computers 6100, 6200, 6300, and 6400, respectively used by the owner 410, life insurance company 420, the Lifegain Provider 430, and third parties that make offers to purchase the life insurance policy 474 from the owner 410 may each be coupled to a network 6000. The network 6000 may be, for example, the Internet or any other wide area or even local area network. A portion of the network 6000, for example, between the owner computer 6100 and the life insurance company computer 6200, may be a local area network, while another portion of the network 6000 (or the entire network) may be part of the Internet. In an embodiment, the Lifegain Provider 430 can use its computer 6300 to determine whether the conditions of the Lifegain Agreement 462 have been complied with before performing their obligations under the Lifegain Agreement 462. Additionally, in another aspect of the invention, the computers 6100, 6200, 6300, and 6400 are used to implement additional features. The computers 61000, 6200, 6300, and 6400 may include at least one world-wide-web server for supporting one or more web based applications for performing the above described tasks. The web based application(s) may be accessible on one or more intranets. The web based application(s) may also be accessible over the global Internet.

While the invention has been described in detail in connection with the exemplary embodiments, it should be understood that the invention is not limited to the above disclosed embodiments. Rather, the invention can be modified to incorporate any number of variations, alternations, substitutions, or equivalent arrangements not heretofore described, but which are commensurate with the spirit and scope of the invention. In another aspect of the system other types of assets can be used in place of the life insurance policy. For example, a paid-up life insurance policy can be used in place of a life insurance policy that has outstanding premium payments. Additionally, in another aspect a contract can be used in place of an SV Policy. Also, the SV Policy or Lifegain Agreement can be priced to provide the owner with more or less protection, i.e., the amount of protection is not necessarily tied to the owner's exposure to life insurance premium payments. Furthermore, although described with reference to an embodiment using a single insurance policy, the invention is not so limited and can utilize more than one insurance policy for use as collateral.

What is claimed as new and desired to be protected by Letters Patent of the United States is:

1. A method for attempting to reduce the risk of financial loss by a first party owner of a life insurance policy, comprising:
purchasing by said first party said life insurance policy;
entering by said first party with a second party into an Agreement that protects against a loss in expected value of said life insurance policy, said Lifegain Agreement including a projected value of said life insurance policy at a specified future time(s);
evaluating a then-current value of said life insurance policy at said specified future time(s); and
determining said loss in value being a difference between said projected value of said life insurance policy and said then-current value of said life insurance policy at said future date(s).

2. The method of claim 1, further comprising the step of:
substantially satisfying by said first party, all conditions required of first party by said agreement.

3. The method of claim 2, further comprising the step of:
providing by said first party to the second party a right to satisfy the second party's obligations under said agreement.

4. The method of claim 3, wherein said second party satisfies its obligations under the said agreement providing by paying said first party substantially said loss in value.

5. The method of claim 3, wherein said second party satisfies its obligations under the said agreement providing by purchasing said life insurance policy from said first party at substantially the projected value of said life insurance.

6. The method of claim 3, further comprising the step of:
receiving by said first party offers to sell said life insurance policy.

7. A method for attempting to reduce the risk of financial loss by a first party owner of a life insurance policy, comprising:
purchasing by said first party said life insurance policy;
purchasing by said first party from a second party an SV Policy for protecting against a loss in expected value of said life insurance policy, said SV Policy including an insured amount of said life insurance policy at a specified future time(s);
evaluating the then-current value of said life insurance policy at said future time(s); and
determining said loss in value being a difference between said covered amount under said SV Policy and said then-current value of said life insurance policy at said future time(s).

8. The method of claim 7, further comprising the step of:
substantially satisfying by said first party, all conditions required of first party by said SV Policy.

9. The method of claim 8, further comprising the step of:
providing by said first party to the second party a right to satisfy the second party's obligations under said agreement.

10. The method of claim 9, wherein said second party satisfies its obligations under said SV Policy providing by paying said first party substantially said loss in value.

11. The method of claim 10, further comprising the step of:
receiving by said first party offers to sell said life insurance policy.

12. A computer system configured to implement a method for attempting to reduce the risk of financial loss by a first party owner of a life insurance policy, said method comprising the steps of:
purchasing by said first party said life insurance policy;
entering by said first party with a second party into an Agreement that protects against a loss in expected value of said life insurance policy, said Lifegain Agreement including a projected value of said life insurance policy at a specified future time(s);
evaluating a then-current value of said life insurance policy at said future time(s); and
determining said loss in value being a difference between said projected value of said life insurance policy and said then-current value of said life insurance policy at said future time(s).

13. The computer system of claim 12, further comprising the step of:
substantially satisfying by said first party, all conditions required of first party by said agreement.

14. The computer system of claim 13, further comprising the step of:
providing by said first party to the second party a right to satisfy the second party's obligations under said agreement.

15. The computer system of claim 14, wherein said second party satisfies its obligations under the said Lifegain Agreement providing by paying said first party substantially said loss in value.

16. The computer system of claim 15, wherein said second party satisfies its obligations under the said agreement providing by purchasing said life insurance policy from said first party at substantially the said projected value of said life insurance.

17. The computer system of claim 15, further comprising the step of:
receiving by said first party offers to sell said life insurance policy.

18. A computer system configured to implement a method for attempting to reduce the risk of financial loss by a first party owner of a life insurance policy, said method comprising the steps of:
purchasing by said first party said life insurance policy;
purchasing by said first party from a second party an SV Policy for protecting against a loss in expected value of said life insurance policy, said SV Policy including an insured amount of said life insurance policy at a specified future time(s);
evaluating the then-current value of said life insurance policy at said future time(s); and
determining said loss in value being a difference between said covered amount under said SV Policy and said then-current value of said life insurance policy at said future time(s).

19. The computer system of claim 18, further comprising the step of:
substantially satisfying by said first party, all conditions required of first party by said SV Policy.

20. The computer system of claim 19, further comprising the step of:
providing by said first party to the second party a right to satisfy the second party's obligations under said agreement.

21. The computer system of claim 20, wherein said second party satisfies its obligations under the said agreement providing by paying said first party substantially said loss in value.

22. The computer system of claim 21, further comprising the step of:
receiving by said first party offers to sell said life insurance policy.
